(19) United States
(12) Patent Application Publication
(10) Pub. No.: US 2019/0059130 A1
(43) Pub. Date: Feb. 21, 2019

(54) COMBINATION WIRELESS ACCESS POINT AND EMERGENCY ASSISTANCE DEVICE

(71) Applicant: Fortinet, Inc., Sunnyvale, CA (US)

(72) Inventor: Qiang Xiao, Surrey (CA)

(73) Assignee: Fortinet, Inc., Sunnyvale, CA (US)

(21) Appl. No.: 15/677,820

(22) Filed: Aug. 15, 2017

(51) Int. Cl. H04W 88/08; G08B 17/10; G08B 21/16; G08B 3/10; H02J 9/02

(52) U.S. Cl. CPC H04W 88/08; G08B 17/10; H04W 84/12; G08B 3/10; H02J 9/02; G08B 21/16

(57) ABSTRACT

A combination device that provides both emergency assistance functionality and wireless AP functionality is provided. The combination device includes an emergency assistance unit, a wireless access point unit and a local area network (LAN) port that is capable of connecting to a computer network. A housing of the combination device encloses the emergency assistance unit, the wireless access point unit and the LAN port.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright © 2017, Fortinet, Inc.

### BACKGROUND

### Field

Embodiments of the present invention generally relate to the field of wireless communications. In particular, various embodiments relate to a combination device that integrates a wireless access point (AP) with an emergency assistance device.

### Description of the Related Art

Usually, in an office area, a large number of emergency assistance devices are mounted on the walls or ceils to help people in case of emergency situations. For example, emergency lights powered by batteries are turned on in the case of a power outage. Smoke and fire alarms may also be triggered when smoke or flames are detected by sensors associated with such emergency assistance devices. Loud speakers may announce emergency messages during special situations. Many wireless APs are also mounted on the ceiling throughout an office area to provide wireless local area network (LAN) (WLAN) coverage. Typically, each of the wireless APs are connected to an AP controller (AC) through a long Ethernet cable across the ceiling. As mounting of emergency assistance devices, APs and cables in an office area is time-consuming and labor-intensive work, there is a need for improved devices that combine the functionality of wireless APs with emergency assistance devices to simplify the deployment and facilitate the implementation of advance features by controlling the emergency assistance device functionality via the AP.

### SUMMARY

A combination device is described that provides both emergency assistance functionality and wireless AP functionality. According to one embodiment, the combination device integrates an emergency assistance unit within a wireless access point. The combination device includes an emergency assistance unit, a wireless access point unit and a local area network (LAN) port that is capable of connecting to a computer network. A housing of the combination device encloses said emergency assistance unit, said wireless access point unit and said LAN port. Construction works for mounting the APs and emergency assistance devices on the ceiling are reduced and the costs for mounting and managing the devices are significantly lowered. Other features of embodiments of the present invention will be apparent from the accompanying drawings and from the detailed description that follows.

### BRIEF DESCRIPTION OF THE DRAWINGS

Embodiments of the present invention are illustrated by way of example, and not by way of limitation, in the figures of the accompanying drawings and in which like reference numerals refer to similar elements and in which:

FIG. 1 illustrates exemplary functional units of a combination device in accordance with a first embodiment of the present invention.

FIG. 2 illustrates exemplary functional units of a combination device in accordance with a second embodiment of the present invention.

FIGS. 3A and 3B illustrate exemplary functional units of combination devices in accordance with a third embodiment of the present invention.

FIG. 4 illustrates exemplary functional units of a combination device in accordance with a forth embodiment of the present invention.

FIG. 5 illustrates exemplary functional units of a network security appliance for managing a combination device in accordance with an embodiment of the present invention.

FIG. 6 is an exemplary computer system in which or with which embodiments of the present invention may be utilized.

### DETAILED DESCRIPTION

A combination device is described that provides both emergency assistance functionality and wireless AP functionality. According to one embodiment, the combination device includes an emergency assistance unit, a wireless access point unit and a local area network (LAN) port that is capable of connecting to a computer network. A housing of the combination device encloses said emergency assistance unit, said wireless access point unit and said LAN port.

### Terminology

Brief definitions of terms used throughout this application are given below.

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

The phrases “in an embodiment,” “according to one embodiment,” and the like generally mean the particular feature, structure, or characteristic following the phrase is included in at least one embodiment of the present disclosure, and may be included in more than one embodiment of the present disclosure. Importantly, such phrases do not necessarily refer to the same embodiment.

If the specification states a component or feature “may”, “can”, “could”, or “might” be included or have a characteristic, that particular component or feature is not required to be included or have the characteristic.

The phrase “networking appliance” generally refers to a specialized or dedicated device for use on a network in virtual or physical form. Some networking appliances are implemented as general-purpose computers with appropriate software configured for the particular functions to be provided by the networking appliance; others include custom hardware (e.g., one or more custom Application Specific Integrated Circuits (ASICs)). Examples of functionality that may be provided by a networking appliance include, but is not limited to, Layer 2/3 routing, content inspection, content filtering, firewall, traffic shaping, application control, Voice over Internet Protocol (VoIP) support, VPN, Internet Protocol (IP) security (IPSec), Secure Sockets Layer (SSL), antivirus, intrusion detection, intrusion prevention, Web content filtering, spyware prevention and anti-spam. Examples of networking appliances include, but are not limited to, network gateways and network security appliances (e.g., FORTIGATE family of network security appliances and FORTICARRIER family of consolidated security appliances), messaging security appliances (e.g., FORTIMAIL family of messaging security appliances), database security and/or compliance appliances (e.g., FORTIDB database security and compliance appliance), web application firewall appliances (e.g., FORTIWEB family of web application firewall appliances), application acceleration appliances, server load balancing appliances (e.g., FORTIBALANCER family of application delivery controllers), vulnerability management appliances (e.g., FORTISCAN family of vulnerability management appliances), configuration, provisioning, update and/or management appliances (e.g., FORTIMANAGER family of management appliances), logging, analyzing and/or reporting appliances (e.g., FORTIANALYZER family of network security reporting appliances), bypass appliances (e.g., FORTIBRIDGE family of bypass appliances), Domain Name Server (DNS) appliances (e.g., FORTIDNS family of DNS appliances), wireless security appliances (e.g., FORTIWIFI family of wireless security gateways), FORIDDOS, wireless access point appliances (e.g., FORTIAP wireless access points), switches (e.g., FORTISWITCH family of switches) and IP-PBX phone system appliances (e.g., FORTIVOICE family of IP-PBX phone systems).

The phrase “security device” generally refers to a hardware device or appliance configured to be coupled to a network and to provide one or more of data privacy, protection, encryption and security. The network security device can be a device providing one or more of the following features: network firewalling, Virtual Private Networking (VPN), antivirus, IPS, content filtering, data leak prevention, antispam, antispyware, logging, reputation-based protections, event correlation, network access control, vulnerability management, load balancing and traffic shaping—that can be deployed individually as a point solution or in various combinations as a UTM solution. Non-limiting examples of network security devices include proxy servers, firewalls, VPN appliances, gateways, UTM appliances and the like.

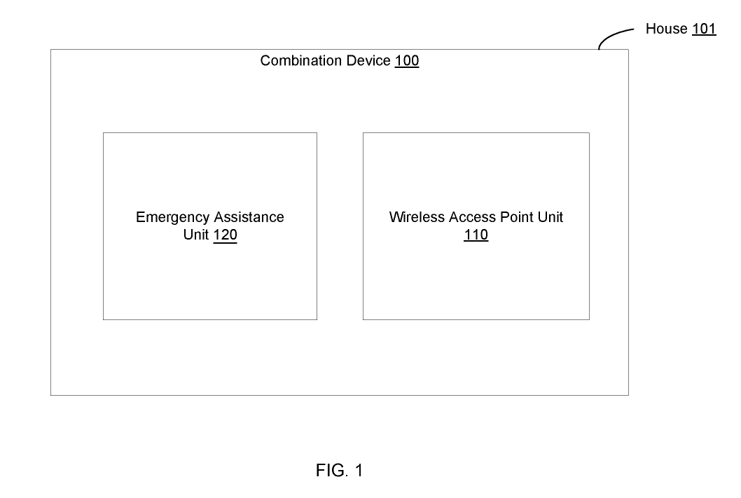

FIG. 1 illustrates exemplary functional units of a combination device 100 in accordance with a first embodiment of the present invention. In the first embodiment, a traditional emergency assistance device is combined with a wireless access point. The combination device 100 of FIG. 1 comprises a wireless AP unit 110 and an emergency assistance unit 120. Wireless AP unit 110 and emergency assistance unit 120 are contained in a common housing 101. In some embodiments, all the hardware of the two units remains separate and the two units may operate independently. In other embodiments, wireless AP unit 110 and emergency assistance unit 120 may operate independently but share a few common parts, such as power units. By integrating an emergency assistance unit with a wireless access point unit, the combination device may be deployed to simplify the installation process.

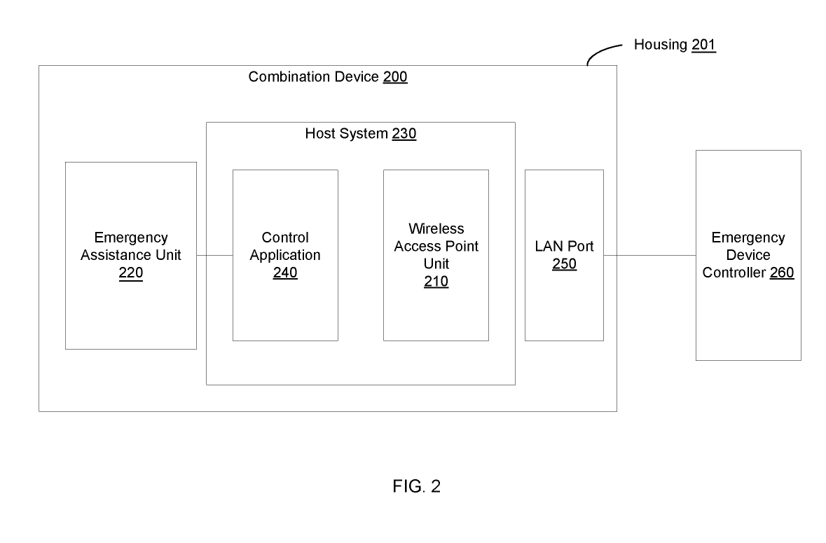

FIG. 2 illustrates exemplary functional units of a combination device 200 in accordance with a second embodiment of the present invention. In the present example, combination device 200 comprises an emergency assistance unit 220 and a wireless access point unit 210 in the form of an application running on a host system 230. Host system 230 may be an operating system, for example, the Linux operating system, which manages software and hardware operations of combination device 200. A LAN port 250, e.g., in the form of an Ethernet port, provides an interface to a network that connects combination device 200 and an access point controller or a network security appliance (not shown). Those skilled in the art will appreciate that LAN port 250 may be used for supplying power to combination device 200 through power over Ethernet (PoE). The PoE provided by LAN port 250 may be used to power wireless access point unit 210 and emergency assistance unit 220. If emergency assistance unit 220 includes a backup battery, the backup battery may be recharged by the PoE.

In the present example, a control application 240 is another application running on host system 230. Control application 240 is used for collecting data captured by emergency assistance unit 220 through an interface with emergency assistance unit 220. When data is received from emergency assistance unit 220, a corresponding command may be sent to emergency assistance unit 220 to drive the operation of the emergency assistance unit 220. In another example, data captured by emergency assistance unit 220 may be transmitted to an emergency device controller 260 through LAN port 250. Emergency device controller 260 is used for managing the operations of emergency assistance unit 220 remotely. Emergency device controller 260 may send out commands to control application 240 in response to data captured by emergency assistance unit 220 and then control application 240 may drive emergency assistance unit 220 based on the commands received from emergency device controller 260. By incorporating a control application in combination device 200 and using a central emergency device controller (e.g., emergency device controller 260) for managing multiple emergency assistance units of a network, more advanced features may be implemented by combination device 200.

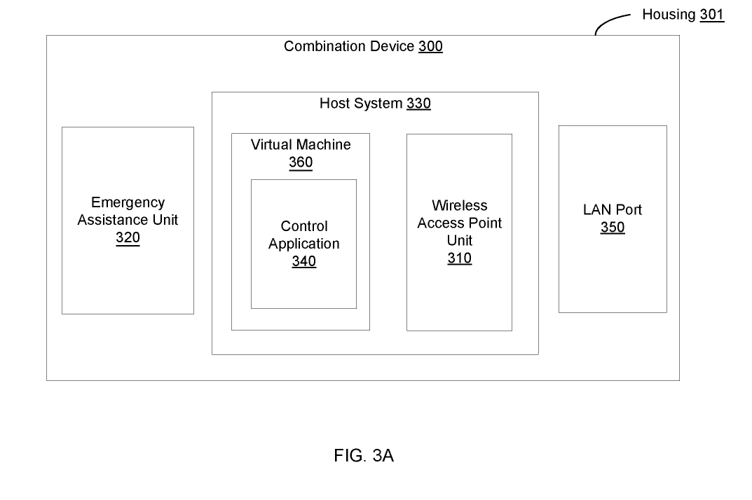

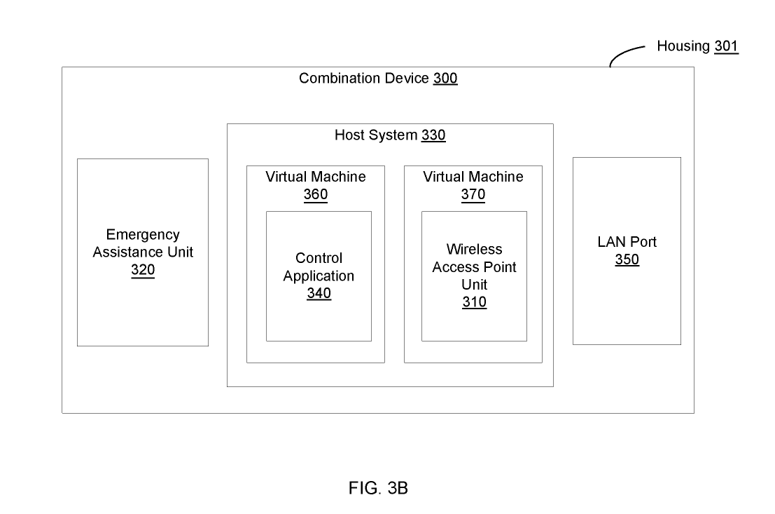

FIG. 3A illustrates exemplary functional units of a combination device 300 in accordance with an embodiment of the present invention. In the present example, combination device 300 comprises an emergency assistance unit 320 and a wireless access point unit 310. A host system 330 hosts a virtual machine 360 that allows control application 340 to run within a separate environment. In this manner, when an error occurs in virtual machine 360, it will not affect wireless access point unit 310 and vice versa.

FIG. 3B illustrates exemplary functional units of a combination device 300 in accordance with an embodiment of the present invention. In the present example, combination device 300 comprises an emergency assistance unit 320 and a wireless access point unit 310. A host system 330 hosts a virtual machine 360 and a virtual machine 370 that allow a wireless access point unit 310 and a control application 340 to be run within separate and independent environments. As in the case of FIG. 3A, in this manner, an error occurring in one unit will not affect the other.

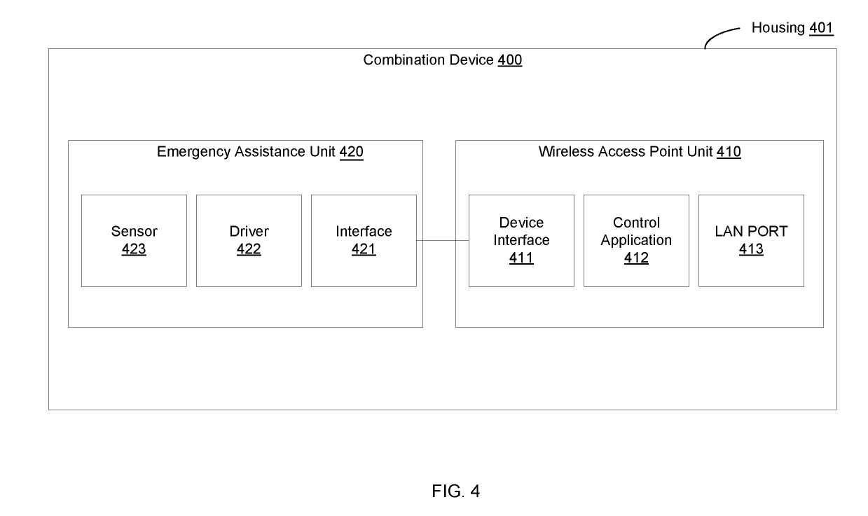

FIG. 4 illustrates exemplary functional units of a combination device 400 in accordance with a forth embodiment of the present invention. In the present example, combination device 400 comprises an emergency assistance unit 420 and a wireless access point unit 410. Emergency assistance unit 420 comprises an interface 421 that can be connected to a device interface 411 of wireless access point unit 410 so as to allow the two units to communicate with each other. Emergency assistance unit 420 also comprises one or more sensors (e.g., a temperature sensor, an ionization sensor, a photoelectric sensor, a carbon monoxide sensor and a power failure sensor), represented by sensor 423, that are capable of capturing environment data or detecting hazardous situations. The data captured by sensor 423 may be sent to a control application 412 through the interfaces of emergency assistance unit 420 and wireless access point unit 410. In this example, control application 412 is implemented as an enhanced function of wireless access point unit 410 and may be configured/managed by wireless access point unit 410 or a wireless access point controller. After receiving data captured by sensor 423, control application 412 may determine what operation(s) is to be taken by emergency assistance unit 420 and send corresponding command(s) to emergency assistance unit 420 through device interface 411. Emergency assistance unit 420 may execute the command(s) received from control application 412 through a driver 422. In another embodiment, the data captured by sensor 423 may be sent to an emergency device controller by control application 412 through a LAN port 423. The emergency device controller may determine the operation(s) based on the data captured by sensor 423 and/or data captured by other emergency assistance units within the same network. Command(s) may be sent back to control application 412 to drive the emergency assistance unit 420 accordingly.

In the present example, emergency assistance unit 420 can be one or more devices that are capable of detecting emergency situations in an area and give warning to people in case of emergency situations. Emergency assistance unit 420 may comprise, but not limited to, emergency lighting device, emergency guiding device, gas/smoke/fire alarm and emergency broadcast system.

In one example, emergency assistance unit 420 may be an emergency lighting device with a rechargeable backup battery and sensor 423 is used for detecting a power failure or failure of PoE. When sensor 423 detects a power failure, the emergency lighting device is activated to provide illumination using the backup battery.

In another example, emergency assistance unit may be a gas/smoke/fire alarm device and sensor 423 is used to detect gas leakage, temperature, smoke or flame. Once sensor 432 is triggered, a siren may be activated by driver 422 to give an audible alarm throughout a building and its surrounding areas.

In a further example, emergency assistance unit may be a broadcast system with a loud speaker. A message may be streamed from an emergency device controller to control application 412 using, for example, Real-time transport Protocol (RTP). Control application 412 may drive the loud speaker to play the message. In the example, the emergency device controller may unicast the message to a single AP or multicast/broadcast the message to a group of APs within the same network.

In a further example, an emergency device controller may coordinate operations of emergency assistance units of a network to provide enhanced features. For example, when a fire signal is captured by a first combination device of a network, the fire signal is transmitted to the emergency device controller over the network. After the alarm signal is received, the emergency device controller may send a lighting command and/or a broadcast message to other combination devices in the neighboring area of the first combination device, thus all the emergency units of neighboring combination devices may be coordinated and provide more assistance to people in the area.

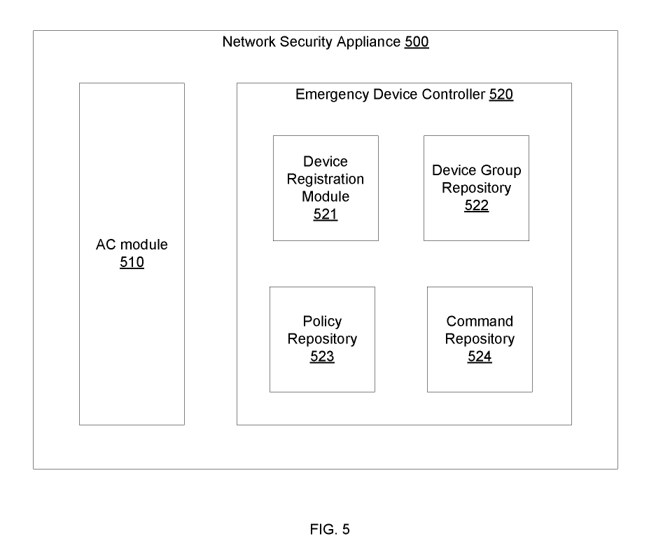

FIG. 5 illustrates exemplary functional units of a network security appliance 500 for managing a combination device in accordance with an embodiment of the present invention. In one embodiment, network security appliance 500 may be a firewall, for example, a FORTIGATE network security appliance available from the assignee of the present invention, that is deployed at the border of an enterprise network for protecting the network from outside attacks. In another embodiment, network security appliance 500 may be a wireless access point controller (AC), for example, a FORTIAP AP controller available from the assignee of the present invention, which is used for controlling APs of an enterprise network. Network security appliance 500 may also be a cloud-based network security service, such as the FORTIGUARD network security subscription service or the FORTICLOUD cloud-based management platform available from the assignee of the present invention, that provide security services over the Internet. In this example, network security appliance 500 comprises an AC module 510 and an emergency device controller 520 for managing operations of a wireless access point unit and an emergency assistance unit of a combination device as described with reference to FIGS. 2-4.

AC module 510 is used for managing the operations of the wireless access point unit through, for example, the Control And Provisioning of Wireless Access Points (CAPWAP) protocol.

Emergency device controller 520 comprises a device registration module 521, a device group repository 522, a policy repository 523 and a command repository 524. When a combination device is connected to the network managed by network security appliance 500, the combination device may register itself with device registration module 521. Device registration module 521 may register the location of and emergency functions supported by the combination device. Device group repository 522 is used for defining groups of combination devices based on location or supported emergency functions of combination devices in order to coordinate the operations of combination devices in the same group. Policy repository 523 includes operation rules for a combination device or a group of combination devices. The operation rules may define what commands and/or messages are to be sent to a combination device or a group device when emergency data is received. Command repository 524 includes commands used for triggering operations of emergency assistance devices. Audible messages to be stream to the emergency assistance devices may be recorded and stored in the command repository 524.

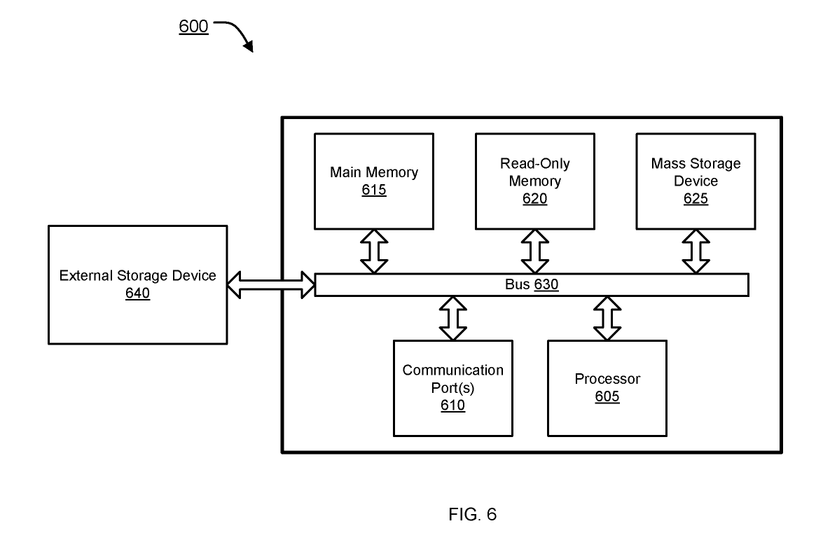

FIG. 6 is an example of a computer system 600 with which embodiments of the present disclosure may be utilized. Computer system 600 may represent or form a part of a network appliance, a wireless access point, an emergency assistance unit, a wireless access point controller, a server or a client workstation.

Embodiments of the present disclosure include various steps, which have been described above. A variety of these steps may be performed by hardware components or may be tangibly embodied on a computer-readable storage medium in the form of machine-executable instructions, which may be used to cause a general-purpose or special-purpose processor programmed with instructions to perform these steps. Alternatively, the steps may be performed by a combination of hardware, software, and/or firmware.

As shown, computer system 600 includes a bus 630, a processor 605, communication port 610, a main memory 615, a removable storage media 640, a read only memory 620 and a mass storage 625. A person skilled in the art will appreciate that computer system 600 may include more than one processor and communication ports.

Examples of processor 605 include, but are not limited to, an Intel® Itanium® or Itanium 2 processor(s), or AMD® Opteron® or Athlon MP® processor(s), Motorola® lines of processors, FortiSOC™ system on a chip processors or other future processors. Processor 605 may include various modules associated with embodiments of the present invention.

Communication port 610 can be any of an RS-232 port for use with a modem based dialup connection, a 10/100 Ethernet port, a Gigabit or 10 Gigabit port using copper or fiber, a serial port, a parallel port, or other existing or future ports. Communication port 610 may be chosen depending on a network, such a Local Area Network (LAN), Wide Area Network (WAN), or any network to which computer system 600 connects.

Memory 615 can be Random Access Memory (RAM), or any other dynamic storage device commonly known in the art. Read only memory 620 can be any static storage device(s) such as, but not limited to, a Programmable Read Only Memory (PROM) chips for storing static information such as start-up or BIOS instructions for processor 605.

Mass storage 625 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), such as those available from Seagate (e.g., the Seagate Barracuda 7200 family) or Hitachi (e.g., the Hitachi Deskstar 7K1000), one or more optical discs, Redundant Array of Independent Disks (RAID) storage, such as an array of disks (e.g., SATA arrays), available from various vendors including Dot Hill Systems Corp., LaCie, Nexsan Technologies, Inc. and Enhance Technology, Inc.

Bus 630 communicatively couples processor(s) 605 with the other memory, storage and communication blocks. Bus 630 can be, such as a Peripheral Component Interconnect (PCI)/PCI Extended (PCI-X) bus, Small Computer System Interface (SCSI), USB or the like, for connecting expansion cards, drives and other subsystems as well as other buses, such a front side bus (FSB), which connects processor 605 to system memory.

Optionally, operator and administrative interfaces, such as a display, keyboard, and a cursor control device, may also be coupled to bus 630 to support direct operator interaction with computer system 600. Other operator and administrative interfaces can be provided through network connections connected through communication port 610.

Removable storage media 640 can be any kind of external hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM).

Components described above are meant only to exemplify various possibilities. In no way should the aforementioned exemplary computer system limit the scope of the present disclosure.

While embodiments of the invention have been illustrated and described, it will be clear that the invention is not limited to these embodiments only. Numerous modifications, changes, variations, substitutions, and equivalents will be apparent to those skilled in the art, without departing from the spirit and scope of the invention, as described in the claims.

1. An apparatus comprising:
an emergency assistance unit;
a wireless access point unit configured to provide wireless local area network (WLAN) coverage within an area of an enterprise;
a local area network (LAN) port that connects the apparatus to a computer network of the enterprise; and
a housing that encloses said emergency assistance unit, said wireless access point unit and said LAN port.

2. The apparatus of claim 1, wherein said emergency assistance unit comprises one or more of:
a broadcast unit;
an emergency light unit;
a gas leakage alarm unit; and
a smoke and fire alarm unit.

3. The apparatus of claim 1, wherein the wireless access point unit further comprises a device interface through which the wireless access point communicates with the emergency assistance unit.

4. The apparatus of claim 3, wherein the wireless access point unit further comprises a control application that communicates with an emergency assistance device controller through the LAN port and communicates with the emergency assistance unit through the device interface.

5. The apparatus of claim 4, wherein the wireless access point unit further comprises a host system.

6. The apparatus of claim 5, wherein said control application and said wireless access point unit run on said host system.

7. The apparatus of claim 5, wherein said host system comprises a virtual machine, wherein said control application runs on said virtual machine and said wireless access point unit runs on the host system.

8. The apparatus of claim 5, wherein said host system comprises a plurality of virtual machines and wherein said control application and said wireless access point unit run on separate virtual machines of the plurality of virtual machines.

9. The apparatus of claim 4, wherein said emergency assistance unit comprises one or more sensors that detect one or more conditions indicative of an emergency situation, and wherein when the emergency situation is detected, information regarding the emergency situation is transmitted to the control application through the device interface.

10. The apparatus of claim 9, wherein the control application directs the emergency assistance unit in accordance with the emergency situation.

11. The apparatus of claim 9, wherein the control application:
transmits the information regarding the emergency situation to the emergency assistance device controller through the LAN port;
receives a command from the emergency device controller; and
controls the emergency assistance unit through the device interface based on the received command.

12. The apparatus of claim 11, wherein the command is transmitted in a form of a unicast message, a multicast message or a broadcast message to the control application by the emergency assistance device controller through a network.

13. The apparatus of claim 4, wherein the apparatus is assigned to a device group based on a physical location of or emergency functionality supported by the emergency assistance unit device and operations of the device group are coordinated by the emergency assistance device controller.

14. The apparatus of claim 4, wherein an audio emergency message is streamed to the control application and played through the emergency assistance unit.

15. The apparatus of claim 1, wherein said emergency assistance unit comprises a rechargeable battery, and said emergency assistance unit is powered and said rechargeable battery is charged by power over Ethernet (PoE) provided by the LAN port.
